(19) United States
(12) Patent Application Publication
(10) Pub. No.: US 2024/0136600 A1
(43) Pub. Date: Apr. 25, 2024

(54) Zinc - Manganese Dioxide - Nickel Hydroxide Secondary Electrochemical Generator

(71) Applicant: SUNERGY, Rosny-sous-Bois (FR)

(72) Inventors: Fabrice Fourgeot, Fontenay-sous-Bois (FR); Shadi Mirhashemihaghighi, Rosny-sous-Bois (FR); Céline Tang, Paris (FR)

(21) Appl. No.: 18/279,341

(22) PCT Filed: Mar. 3, 2022
(86) PCT No.: PCT/IB2022/051880

§ 371 Date: Aug. 28, 2023

(30) Foreign Application Priority Data
Mar. 3, 2021 (FR) FR2102083

(51) Int. Cl. H01M 10/26; H01M 4/36; H01M 4/50; H01M 4/52; H01M 4/58

(52) U.S. Cl. CPC H01M 10/26; H01M 4/364; H01M 4/50; H01M 4/52; H01M 4/58; H01M 2004/028

(57) ABSTRACT

The invention relates to a zinc-manganese dioxide secondary electrochemical generator which has the particular feature that it comprises: a) a positive hybrid electrode containing a mixture of manganese dioxide (MnO2) and nickel hydroxide (Ni(OH)2), the mass of Ni(OH)2 being greater than 5% of the sum of the masses of Ni(OH)2 and MnO2, and b) an electrolyte which is an alkaline aqueous solution, the molarity of which is between 4 M and 15 M of hydroxyl anions.

The present invention relates to the field of accumulators and more particularly that of alkaline electrochemical generators. It relates especially to zinc-manganese dioxide secondary generators with a high number of charge-discharge cycles.

### BACKGROUND OF THE INVENTION

Zn/MnO₂ primary batteries are commonly used, while secondary batteries of this Zn/MnO₂ system remain a challenge. The reversibility of this system is considered very limited. On the positive pole side, cathode MnO₂, irreversible compounds are formed during discharge, such as hausmannite (Mn₃O₄) and hetaerolite (ZnMn₂O₄), leading to a rapid and significant loss of capacity. On the negative pole side, the Zn anode, the phenomena of shape changes, passivation, and dendrite formation limit the reversibility particularly when the zinc anodes are charged-discharged at high current densities and the utilization rate of the theoretical capacity is greater than 10%^{2′3}.

The reduction of MnO₂ in the alkaline medium takes place in two stages: First stage of reduction: MnO₂+H₂O+e⁻->MnOOH+OH⁻ (1) Second stage of reduction: MnOOH+H₂O+e⁻->Mn(OH)₂+OH⁻ (2) The first stage of reduction is characterized by a drop in voltage from 1.5 V to 0.9 V. The potential of the homogeneous solid-state insertion of electrons-protons into MnO₂, reducing the oxidation state of the Mn atoms from 4+ to 3+, resulting in the formation of MnOOH. However, this process is also associated with a partial amorphization mechanism of the host crystallographic structure as a result of steric strains related to the insertion of protons (H⁺) and the increase in ionic radiation of the Mn cation (Mn³⁺ vs. Mn⁴⁺). This insertion can be reversible in a limited range of H⁺ insertion in accordance with a limited amorphization process, up to H_{0.7}MnO₂ (1.1-1 V) according to Patrice⁵ or H_{0.7}MnO₂ according to Gallaway⁶. MnOOH can further be reduced below 0.9 V, to Mn(OH)₂, in what is called the second stage electron and via a heterogeneous dissolution (MnOOH to Mn³⁺)-reduction (Mn³⁺ to Mn²⁺)-precipitation (Mn²⁺ to Mn(OH)₂) process. According to several studies, the second stage can take place before the completion of the first stage (the insertion of the first electron) due to the instability of MnOOH and the dissolution of Mn³⁺ in the electrolyte. Mn(OH)₂ forming in the reaction (2) is considered a reversible discharge product, but it is not the only product that is formed in practical cases and in exchange for a Zn electrode. MnOOH is susceptible to reacting with the ions of the electrolyte according to a mechanism described by the chemical reactions (3) and (4) involving the formation of electrochemically inert reaction products, hetaerolite (ZnMn₂O₄) and hausmannite (Mn₃O₄):

2MnOOH+Zn(OH)₄²⁻->ZnMn₂O₄+2OH⁻+2H₂O (3)

2MnOOH+Mn(OH)₄²⁻->Mn₃O₄+2OH⁻+2H₂O (4)

The irreversibility of the reduction of MnO₂ is therefore strongly correlated with the formation of the compounds Mn₃O₄ and ZnMn₂O₄. Once Mn₃O₄ is formed during the first discharge, this compound can only be partially reduced to Mn(OH)₂ while ZnMn₂O₄ is not reduced to Mn(OH)₂ at all. To increase the number of charges-discharges of MnO₂ electrodes, different approaches were tried. Kordesch et al.^{1,7,8,9} showed that γ-MnO₂ is rechargeable with a greater number of cycles only if the discharge is limited to less than 35% of the first reduction stage. More recently, Ingale et al.¹⁰ followed this strategy aimed at improving cyclability with a limited capacity of 5% to 20% DoD (depth of discharge). With inexpensive battery materials, they show a stable capacity during 3,000 cycles for 10% DoD and 500 cycles for 20% DoD. Other studies have shown an improvement in the life of the MnO₂ electrode by using additives such as CeO₂, MgO, TiS₂, Bi₂O₃ or Ba- and Sr-based compounds allowing a limitation of the inert phases of manganese oxide and a maintenance of the γ-MuO₂ phase during the cycling^{11′12′13′14,15,16}.

Kannan et al.¹³ show that MnaO₄ with Bi₂O₃ has a capacity that increases over 100 cycles to more than 400 mAh/g, demonstrating that the addition of Bi₂O₃ is capable of reactivating the normally inactive Mn₃O₄ compound. However, it should be noted that these cathodes cannot be charged-discharged for more than 20 or 30 cycles in the presence of zinc anodes, as the dissolved zincate ions combine with the manganese ions to produce inactive ZnMn₂O₄ during the process of discharging the second electron from the MnO₂ cathode.

As other examples, a flat plate Zn/MnO₂ cell was developed by Stani et al.¹⁷ with MnO₂ modified by the addition of BaSO₄, which minimizes capacity loss, but only 25 to 30 cycles were obtained.

Recently, Yadav et al.¹⁸ performed 1,000-6,000 cycles for the complete process of the two discharge stages. This result is correlated with the stabilization of the δ-MnO₂ birnessite structure by the insertion of bismuth and copper additives as well as the addition of carbon nanotubes. This result is, however, obtained opposite a nickel electrode, meaning without the presence of zincate ions. Although a remarkable achievement, the MnO₂ electrodes are still sensitive to Zn poisoning (irreversibly forming ZnMn₂O₄) and also required an initial procedure in exchange for a Ni(OH)₂ electrode in order to “form” the electrodes before they could be paired with a Zn anode to form the Zn/MnO₂ battery. In comparison, only 900 cycles are obtained in the presence of a zinc electrode¹⁹. In addition, the latter result is obtained with the addition of a Ca(OH)₂ membrane to trap zincate ions and limit the formation of ZnMn₂O₄.

Maria Kelly et al.²¹ showed that triethanolamine (TEA) as an additive in Zn/MnO² with a discharge limited to 10% significantly increases stability with 191 cycles without TEA and 568 cycles with TEA. The purpose of the present invention is to provide a novel response to the limits affecting the ability of MnO₂ electrode-based accumulators to provide a large number of cycles. To do this, tests concern the addition of Ni(OH)₂ compounds to the composition of the positive MnO₂-based electrode, this electrode becoming a de facto hybrid, MnO₂ and Ni(OH)₂ together being electrochemically active. The idea is to provide, by the presence of stable Ni(OH)₂/NiOOH crystallites in the alkaline electrolyte, a crystal growth substrate for the MnOOH/MnO₂ compounds. This support of crystal growth is susceptible to increasing the reversibility of the electrochemical couple MnOOH/MnO₂ by an increase in the coherence domains of these compounds which limits the reactivity of MnOOH with the electrolyte ions and de facto the formation of parasitic reactions in the (3) formation of hetaerolite (ZnMn₂O₄) and the (4) formation of hausmannite (Mn₃O₄).

Examination of the state-of-the-art of Zn/MnO₂ systems shows that there are several patents and studies mentioning the use of Ni(OH)₂ in the MnO₂ electrode. A portion of these patents citing an electrochemical cell with a cathode characterized by a mixture of MnO₂ and NiOOH relate to primary, and therefore non-rechargeable, systems. It is evident that, with the addition of NiOOH, the Ni(OH)₂ charged state, to the MnO₂ electrode, the ZnMnO₂ battery can be discharged at a higher rate with a higher voltage, providing more energy for devices requiring more power or operating with a higher voltage. For example, the international patent application published under no. WO2006/026232 indicates, for an alkaline battery with a zinc anode, a cathode containing both NiOOH and manganese dioxide. It mentions better capacity maintenance for higher discharge densities with an MnO₂/NiOOH mixture. However, this patent concerns primary batteries and not the rechargeable system. There are no reported effects on a possible improvement in the cycling ability of Zn/MnO₂ batteries.

Contrary to the results concerning this invention, T. N. Ramesh et al. report that a mixture of MnO₂ and Ni(OH)₂ materials is not ready for use in an electrochemical storage application. However, an NiO(OH)/MnO₂ composite phase obtained by common coprecipitation of the Ni²⁺ and Mn²⁺ ions is mentioned as being capable of greatly increasing the capacity by up to 2.25 electrons per metal atom, equivalent to 650 mAh/g. Only 20 cycles have been demonstrated.

Another portion of the patents citing the addition of Ni(OH)₂ to the MnO₂ electrode relates to rechargeable ZnMnO₂ batteries. In these patents, it is mentioned that the addition of Ni(OH)₂, which must remain low, makes it possible to reduce the problems of recharging the MnO₂ electrodes by limiting the formation of oxygen at the end of the charge. For patent U.S. Pat. No. 5,011,752, the MnO₂ used is preconditioned to lower the degree of oxidation of the manganese atom to be compatible with the MnOₓ formulation, where x is between 1.70 and 1.90. It is reported that 1.68% Ni(OH)₂ is added to the composition of the MnO₂ cathode to limit the overcharge of manganese dioxide and the formation of oxygen, which are the result of premature failures of the manganese dioxide cathode. The addition of Ni(OH)₂ is a reserve of materials capable of reducing the consequences of MnO₂ cathode overcharges. No value table is provided to support the beneficial action of adding Ni(OH)₂. The Ni(OH)₂ content is very low, less than 2%. The number of cycles demonstrated is only 5. In patent CN 104,701,521 A, it is mentioned that 5% by mass Ni(OH)₂ is added to the composition of the positive MnO₂ electrode, the percentage by mass being relative to the mass of the active material of the positive MnO₂ electrode. The charge is capped at a constant voltage of 1.65 V, which limits the formation of oxygen. The voltage of 1.65 V is the quiescent voltage of the NiZn system. As a result, the Ni(OH)² compound in the MnO₂ electrode composition must not participate in the electrochemical reaction because a maximum voltage of 1.65 V does not allow the charge of the compound Ni(OH)² to NiOOH. The action of Ni(OH)² is not described, but it is reasonable to think that the desired action is similar to U.S. Pat. No. 5,011,752, with a limitation on the overcharge of manganese dioxide and the formation of oxygen.

In patent JP H10 74511 A, the addition of nickel hydroxide and nickel oxide to a rechargeable MnO² electrode is mentioned. The composition of the MnO₂ electrode is such that the atomic ratio of the Ni atom to the Mn atom corresponds to a range of 2% to 35%. Once again, this invention relates to recharging the MnO₂ electrodes in alkaline solution by limiting the generation of oxygen. In this patent, a figure is given making it possible to compare the voltages during charging with and without the addition of Ni(OH)₂. Following the addition of Ni(OH)₂, the charge curve is characterized by a double plateau before a final increase correlated with the development of oxygen. The second plateau, above 1.85 V, corresponds to the charge of Ni(OH)₂. The very pronounced voltage difference between the first and second plateau allows better end-of-charge detection and a reduction in oxygen development.

Without the addition of Ni(OH)₂ to the MnO₂ electrode, the number of cycles is 18. The addition of Ni(OH)₂ makes it possible to increase this number of cycles to 54 and 62, respectively, for 9.1% and 10% atomic for the Ni/(Mn+Ni) ratio. For ratios greater than 10%, the number of cycles decreases to 37 when the Ni/(Mn+Ni) ratio is 45%. It is also indicated that the amount of nickel must remain low in order to preserve the discharge amount of the MnO₂ compound.

State-of-the-art research mentioning the addition of Ni(OH)₂ to the rechargeable MnO₂ electrode is all related to a reduction in the formation of oxygen at the end of charging. In addition, it is mentioned that the amount of nickel must remain low in order to preserve the discharge amount of the MnO₂ compound. None of these documents mentions or seeks out an improvement in the stability and cycling life of the battery that would result from a mixture of Ni(OH)₂ and MnO₂ compounds, making it possible to increase the reversibility of the electrochemical couple MnOOH/MnO₂ linked to a substrate action of the Ni(OH)₂/NiOOH compounds allowing better coherence of the MnOOH/MnO₂ structures.

Patents and studies mentioning the addition of Ni(OH)₂ to an MnO₂ electrode cannot therefore anticipate the invention described in the present patent, which is based on seeking out this particular and novel effect that makes it possible to stabilize the discharge capacity of an electrode composed of a mixture of MnO₂ and Ni(OH)₂.

### BRIEF SUMMARY OF THE INVENTION

The goal of the present invention is to increase the cycling life of secondary electrochemical generators. It therefore aims to provide a novel response to the limits affecting the ability of the MnO₂ electrode to provide a large number of cycles, with a discharge greater than 35% of the first reduction stage, a response provided by modifying the conditions of capacity loss of the MnO₂ electrode by limiting the formation of an electrochemically inert crystal structure.

More specifically, the invention relates to a zinc-manganese dioxide secondary electrochemical generator according to the following statement 1:

1. A zinc-manganese dioxide hybrid secondary electrochemical generator, this generator being distinguished in that it comprises:
a) a positive hybrid electrode containing a mixture of manganese dioxide (MnO₂) and nickel hydroxide (Ni(OH)₂), the mass of Ni(OH)₂ preferably being greater than 5% of the sum of the masses of Ni(OH)₂ and MnO₂, and
b) an electrolyte that is an alkaline aqueous solution with a molarity of between 4 M and 15 M of hydroxyl anions (OH⁻). This hybridization, by constituting a positive electrode combining manganese dioxide and nickel hydroxide, makes it possible to produce an economical secondary system, thanks to the low cost of MnO₂, benefiting from good cycling ability, thanks to the excellent reversibility between Ni(OH)₂ and NiOOH. This cyclability is further reinforced when the zinc negative electrode incorporates conductive ceramic powders, as described in patent FR 2,788,887, and in particular titanium nitride. Advantageous characteristics of the hybrid secondary electrochemical generator in the aforementioned statement 1 are indicated in the following statements 2 to 10:

2. A secondary electrochemical generator according to statement 1, in which the mass of Ni(OH)₂ is greater than 20% of the sum of the masses of Ni(OH)₂ and MnO₂.

3. A secondary electrochemical generator according to statement 1 or 2, in which the zinc negative electrode contains conductive ceramics.

4. A secondary electrochemical generator according to statement 3, in which the zinc negative electrode contains titanium nitride.

5. A secondary electrochemical generator according to one of statements 1 to 4, the molarity of the alkaline solution is between 7 and 13 M.

6. A secondary electrochemical generator according to one of statements 1 to 5, in which the alkalinity of the electrolyte solution is provided by lithium hydroxides and/or sodium hydroxides and/or potassium hydroxides.

7. A secondary electrochemical generator according to one of statements 1 to 6, in which the electrolyte further contains zincate ions (Zn(OH)₄²⁻).

8. A secondary electrochemical generator according to one of statements 1 to 7, in which the electrolyte further contains borates, silicates, and/or aluminates. Other characteristics and advantages of the invention will now be described in detail in the following description which is given with reference to the appended figures, which schematically show:

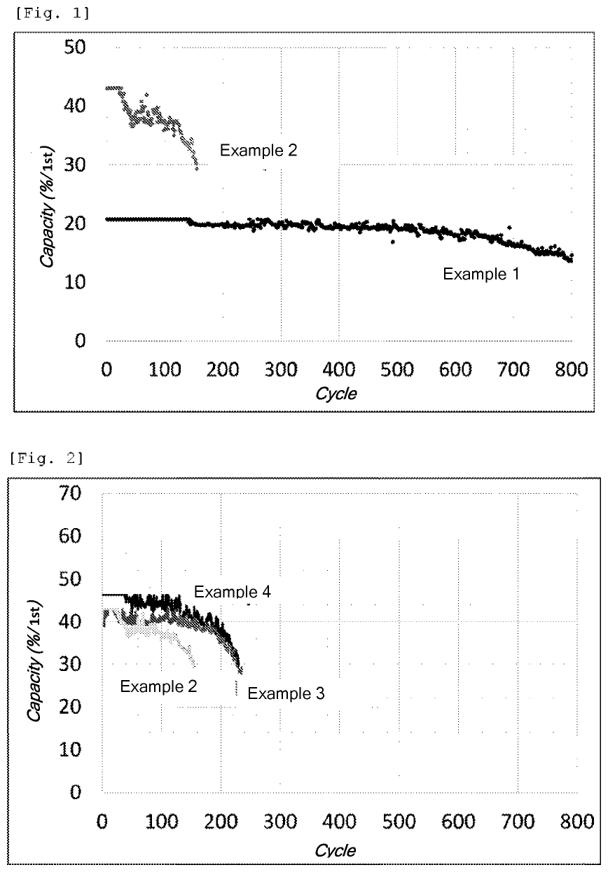

FIG. 1: the change in capacity as a function of the number of cycles of the electrochemical generators of examples 1 and 2;

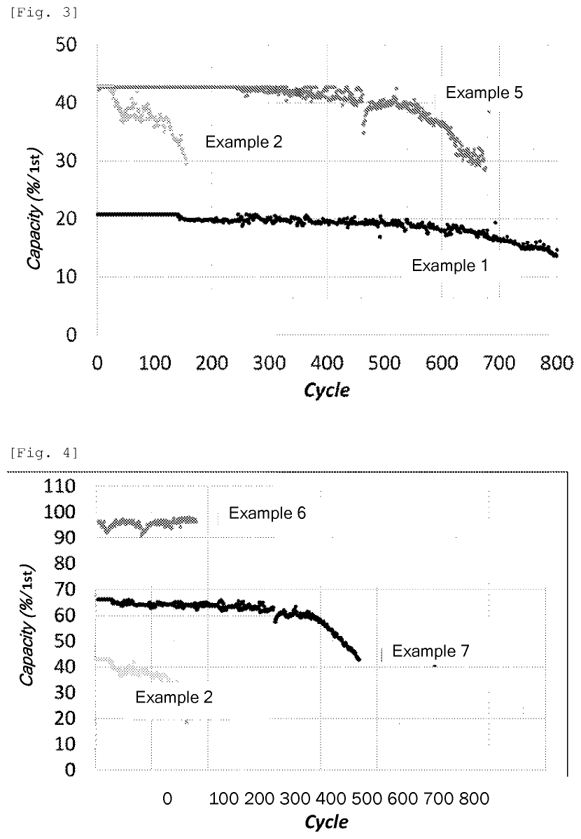

FIG. 2: the change in capacity as a function of the number of cycles of the electrochemical generators of examples 2, 3, and 4;

FIG. 3: the change in capacity as a function of the number of cycles of the electrochemical generators of examples 1, 2, and 5;

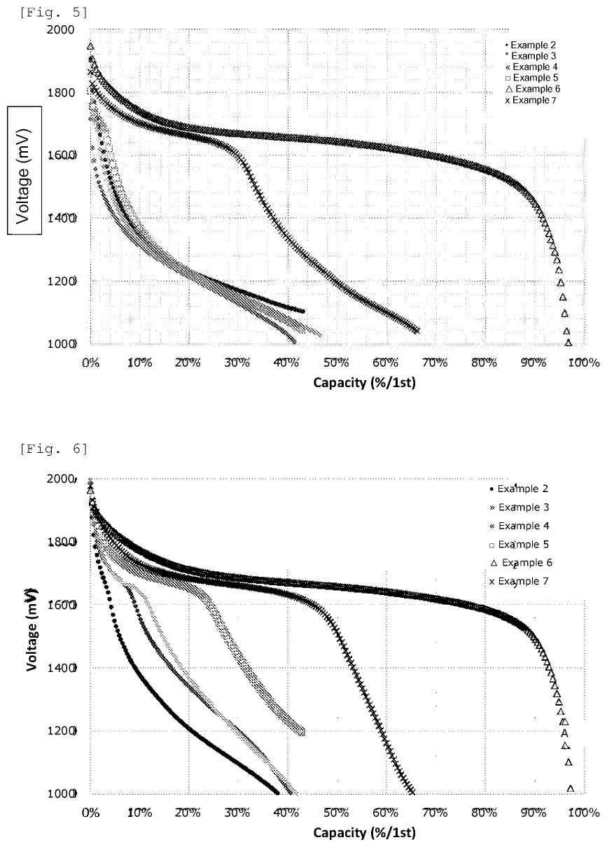

FIG. 4: the change in capacity as a function of the number of cycles of the electrochemical generators of examples 2, 6, and 7;

FIG. 5: the voltage-capacity profiles at cycle no. 5 for the electrochemical generators of examples 2 to 7;

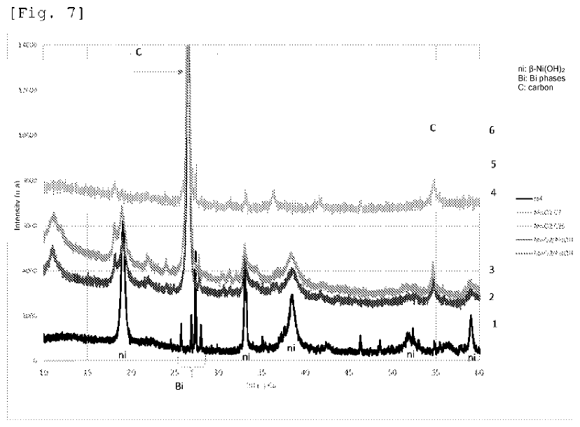

FIG. 6: the voltage-capacity profiles at cycle no. 50 for the electrochemical generators of examples 2 to 7; and

FIG. 7: the X-ray diffraction patterns of the electrochemical generators of examples 1 to 6.

### DETAILED DESCRIPTION OF THE INVENTION

The authors of the present invention have shown that adding Ni(OH)₂ to the active material of the cathode makes it possible to reduce the capacity losses linked to the MnO₂ phase and to significantly increase the capacity of the MnO₂/Ni(OH)₂ hybrid electrode.

According to the present invention, and as illustrated by the non-exhaustive examples of demonstration and embodiment that follow, the active material of the positive electrode comprises a mixture of manganese dioxide and nickel hydroxide, the mass of Ni(OH)₂ being greater than 5% of the sum of the masses of Ni(OH)₂ and MnO₂ and, preferably, greater than 20% of the sum of the masses of Ni(OH)₂ and MnO₂.

The manganese dioxide can be supplied to the preparation of the cathode by all chemical and electrochemical varieties of MnO₂. Similarly, nickel hydroxide can be added by all varieties of Ni(OH)₂, including all usual crystallographies and additives. The electrolyte used according to the present invention is an alkaline aqueous solution with a molarity of between 4 and 15 M, and preferably between 7 and 13 M, of hydroxyl anions. It can be composed of lithium, sodium, or potassium hydroxides taken alone or in mixtures.

The electrolyte may also contain zincates, borates, silicates, and/or aluminates, in varied proportions.

The zinc negative electrode preferably incorporates conductive ceramic powders, which can be selected from the borides, carbides, nitrides, and silicides of various metals such as: hafnium, magnesium, niobium, titanium, and vanadium. It may thus advantageously be hafnium nitride and/or carbide, and/or magnesium carbide and/or nitride and/or silicide, and/or niobium carbide and/or nitride, and/or titanium carbide and/or nitride and/or silicide, and/or vanadium nitride. It is also possible to use ceramic materials such as titanium suboxides of a general TiₙO2ₙ₋₁ formula, where n is between 4 and 10. For both, these ceramics can be retained for use in the context of the present invention, insofar as they are conductive, chemically inert in the battery, and have a high hydrogen overvoltage. In addition, in order for them to fulfill their role optimally, these conductive powders used should be fine and dispersed as homogeneously as possible in the active mass.

### Example 1 (Prior Art)

An electrochemical cell of prismatic format consists of two zinc electrodes framing an MnO₂ electrode. Each zinc electrode has an active surface of 26 cm² for a capacity of 1.5 Ah. The MnO₂ electrode with an active surface area of 24 cm² and a capacity of 0.588 Ah calculated for the equivalent of an exchanged electron corresponding to the first reduction stage between MnO₂ and MnOOH or 308 mAh/g, therefore has a capacity limiting the capacity of the Zn/MnO₂ electrochemical cell.

Each zinc and MnO₂ electrode is enveloped by a membrane in order to confine soluble Zn and Mn ions to the electrode surface. A piece of felt is also positioned between each electrode as a separator and electrolyte reservoir.

The composition of the active material of the zinc electrode includes TiN conductive ceramics, as described in patent FR 2,788,887, to eliminate the cyclability problems of the zinc electrode. The composition of the active material of the MnO₂ electrode consists of, expressed by mass, 60% MnO₂-EMD (electrolytic manganese dioxide), 6% Bi₂O₃, 30% carbon, and 4% binder-plasticizer (PTFE). Alcohol is added to the mixture of the preceding constituents to obtain a compact paste that is then prepared in the form of strips, which are deposited on each side of a current collector, the whole being compacted to obtain an MnO₂ electrode.

The electrolyte is an alkaline aqueous solution with a molarity of 10 M, obtained from a mixture of NaOH and KOH. The electrolyte also contains 0.25 M of zincate ions obtained by the addition of ZnO.

The first two cycles at the C/20 rate are used as the training stage. The ZnMnO₂ battery thus made is first discharged at a rate of C/20, up to 1 V or the equivalent of 20% of the capacity. Charging is done at C/20 with no voltage limit up to an equivalent of 21% of the capacity. After 2 cycles, the element of example 1 is cycled under the same conditions as the first two cycles but with a current rate equivalent to C/10. The capacity of example 1 as a function of the number of cycles is shown in FIG. 1. The utilization rate of MnO₂ is 20% relative to 308 mAh/g and leads to an average surface capacity for the first 150 cycles of 5 mAh/cm². With a 30% initial loss of capacity, the life is estimated at 786 cycles. The capacity is particularly stable during the first 150 cycles.

### Example 2 (Prior Art)

The cell of example 2 is identical to that of example 1. The capacity of the MnO₂ electrode is 0.644 Ah. The utilization rate of the MnO₂ electrode is increased to have a surface capacity greater than 10 mAh/cm².

The example 2 battery thus made is first discharged at a rate of C/20, up to 1 V or the equivalent of 43% of the capacity calculated on the basis of one exchanged electron or 308 mAh/g of MnO₂. Charging is done at C/20 with no voltage limit up to an equivalent of 45% of the capacity. After 2 cycles, the element of example 2 is cycled under the same conditions as the first two cycles but with a current rate equivalent to C/10.

The capacity of example 2 is shown in FIG. 1. The discharge of MnO₂ at 43% makes it possible to have an initial surface capacity of 11.6 mAh/cm². The average surface capacity of the first 150 cycles is 10.3 mAh/cm². Only 155 cycles, instead of 786 for example 1, are performed before a reduction greater than 30% of the initial capacity. The capacity is stable for 20 cycles. Example 2 demonstrates that, for a surface capacity greater than 10 mAh/cm², a discharge of 43% MnO₂ is necessary under the experimental conditions of examples 1 and 2. The doubling of the surface capacity from 5 mAh/cm² for example 1 to 10 mAh/cm² for example 2 is associated with a drastic drop in life. This is divided by 5, going from 786 to 155 cycles. This drop in life with the increased discharge of the MnO₂ compound is in accordance with previous observations reporting the formation of parasitic compounds Mn₃O₄ and ZnMn₂O₄ according to reactions (3) and (4).

The capacities of examples 1 and 2 as a function of the number of cycles can be seen in FIG. 1.

### Example 3 (Comparative)

Example 3 is similar to example 2 with a positive electrode modified by the addition of 3.75% Ni(OH)₂ to the MnO₂ electrode. The composition of the active material of the positive electrode modified by the addition of nickel hydroxide to replace part of the MnO₂ is, by mass, 56.25% MnO₂-EMD, 3.75% Ni(OH)₂, 6% Bi₂O₃, 30% carbon, and 4% binder-plasticizer.

The positive electrode becomes hybrid with 2 electrochemically active materials in the voltage range between 1 V and 2.3 V. The capacity is calculated by considering for this voltage range an electron exchanged for each active material, or 308 mAh/g for MnO₂ and 289 mAh/g for Ni(OH)₂. The capacity of the hybrid electrode of example 3 is 0.690 Ah.

Example 3 is formed and cycled under the same conditions as example 2 with a 43% discharge. With this 43% discharge, the minimum discharge of MnO₂ is 40% based on a 100% discharge for nickel hydroxide. The capacity of example 3 is shown in FIG. 2. The life of this example is measured at 226 cycles, greater than that of example 2 at 155 cycles. The average surface capacity of the first 150 cycles of example 3 is 12.1 mAh/cm², higher than that of example 2 by 10.3 mAh/cm². With the addition of 3.75% of Ni(OH)₂, example 3, compared to example 2, increases the surface capacity by 17% and life by 46%.

### Example 4 (Comparative)

Example 4 is identical to example 2 with a positive electrode modified by the addition of 7.5% Ni(OH)₂ to the MnO₂ electrode. The composition of the positive MnO₂ electrode becomes, by mass, 52.5% MnO₂-EMD, 7.5% Ni(OH)₂, 6% Bi₂O₃, 30% carbon, and 4% binder-plasticizer. The capacity of the electrode of example 4 is 0.654 Ah.

Example 4 is formed and cycled under the same conditions as example 2 but with a greater discharge (47%), allowing a minimum 40% MnO₂ discharge, identical to that of examples 2 and 3. The discharge of nickel hydroxide is considered to be 100%. The capacity of example 4 is shown in FIG. 2. The life of this example is measured at 224 cycles, greater than that of example 3. The average surface capacity of the first 150 cycles of example 4 is 12.1 mAh/cm², identical to that of example 2. With the addition of 7.5% of Ni(OH)₂, example 4 gives results similar to those of example 3, with an increase in surface capacity of 17% and an increase in life of 45%, compared to example 2. This identical result of example 4 is obtained with a discharge of 47%, greater than the 43% of example 3, suggesting that the presence of Ni(OH)₂ in the composition of the MnO₂ electrode limits the capacity losses of this MnO₂ compound.

### Example 5 (Comparative)

Example 5 is similar to example 2 with a positive electrode modified by the addition of 15% Ni(OH)₂ to the MnO₂ electrode. The composition of the positive MnO₂ electrode becomes, by mass, 45% MnO₂-EMD, 15% Ni (OH)₂ 6% Bi₂O₃, 30% carbon, and 4% binder-plasticizer. The capacity of the electrode of example 5 is 0.616 Ah.

Example 5 is cycled under the same conditions as example 2. With this same 43% discharge, the minimum discharge of MnO₂ is 26% for example 5, based on a 100% discharge for nickel hydroxide. The capacity of example 5 is shown in FIG. 3. The life of this example 5 is measured at 673 cycles, greater than that of example 2 at 155 cycles. The average surface capacity of the first 150 cycles of example 5 is 11.1 mAh/cm², higher than that of example 2 by 10.3 mAh/cm². With the addition of 15% of Ni(OH)₂, example 5, compared to example 2, increases the surface capacity by 8% and life by 334%. This increase of 7 times greater than that measured in examples 3 and 4 is related to the discharge of MnO₂ at 26%, lower than the 40% of examples 3 and 4. The number of cycles during which the initial capacity is perfectly stable in example 5 is greater than example 1 with respectively 243 and 139 cycles. The addition of 15% Ni(OH)₂ to the MnO₂ electrode makes it possible to increase this range of perfect stability of the positive electrode by 75%, even though the minimum discharge of the MnO₂ compound is increased by 30%, from 20% to 26%. The addition of 15% Ni(OH)₂ remarkably increases the stability of the MnO₂ electrode, even with an increase in the discharge percentage of the MnO₂ phase. For the same discharge rate of the electrode, the life is increased by more than 300% with surface capacities greater than 10 mAh/cm².

### Example 6 (Prior Art)

Example 6 is similar to example 2 with a positive electrode modified by the addition of Ni(OH)₂, fully replacing the MnO₂ compound with Ni(OH)₂. The composition of the positive electrode becomes, by mass, 60% Ni(OH)₂, 6% Bi₂O₃, 30% carbon, and 4% binder-plasticizer. The capacity of the electrode of example 6 is 0.533 Ah. Example 6 is cycled at the same current rate as example 2, with a charge at C/10 102% of the capacity with no voltage limit and a discharge at C/10 up to 1 V. These cycling conditions reproduce a charge and a complete discharge of nickel hydroxide identical to that of examples 3, 4, and 5. The discharge capacity obtained from example 6 is characterized by an average value over the first 150 cycles of 95%, less than the assumed 100% of examples 3, 4, and 5. The average surface capacity over the first 150 cycles is 22.1 mAh/cm². The capacity of example 6 is shown in FIG. 4.

### Example 7 (Comparative)

Example 7 is similar to example 2 457 cycles, greater than with a positive electrode modified by the addition of 30% Ni(OH)₂ to the MnO₂ electrode. The composition of the positive MnO₂ electrode becomes, by mass, 30% MnO₂-EMD, 30% Ni(OH)₂, 6% Bi₂O₃, 30% carbon, and 4% binder-plasticizer. The capacity of the hybrid electrode of example 7 is 0.529 Ah. Example 7 is formed and cycled with the same conditions as example 2 with a 66% discharge. With this 66% discharge, the minimum discharge of MnO₂ is 37% based on a 100% discharge for nickel hydroxide. However, example 6 demonstrates that for a 100% discharge of Ni(OH)₂, the capacity obtained is not 100% but 95%, implying a minimum discharge for MnO₂ of 41%, very close to the 43% of example 2. The capacity of example 7 is shown in FIG. 4. The life of this example 7 is measured at that of example 2 at 155 cycles. The average surface capacity of the first 150 cycles of example 7 is 14.6 mAh/cm², higher than that of example 2 by 10.3 mAh/cm². For a discharge of the MnO₂ compound of 41-43% equivalent to examples 2 and 7, the addition of 30% of Ni(OH) 2 in example 7 increases, relative to example 2, the surface capacity by 42% and the life by 195%. Table 1 below groups, for the 7 previous examples, the percentage of discharge of the positive electrode, the minimum percentage of discharge of the compound MnO₂, the average surface capacity over the first 150 cycles, and the life and the increase, relative to example 2, of the surface capacity and the life, following the addition of Ni(OH)₂ to the composition of the positive electrode. The greater the addition of Ni(OH)₂, the longer the life for an identical MnO₂ use rate, such as 41-43%. For a lower rate like 26%, the life is greatly increased. The increase in life is in accordance with a reduction in the formation of parasitic phases Mn₃O₄ and ZnMn₂O₄.

| | | % mass | | | Ave. surface | | Increase relative | |
|---|---|---|---|---|---|---|---|---|
| | Addition of | Ni (OH)₂/ | | Min. rate of | capacity | | to example 2 | |
| | Ni (OH)₂ to | (mass | Discharge of | use of the | over 150 | | Surface | Life |
| | the positive | Ni (OH)₂ + | the positive | compound | cycles | Life in | capacity | in |
| Ex. | electrode (%) | MnO₂) | electrode (%) | MnO₂ | (mAh/cm² | cycles | (mAh/cm² | cycles |
| 1 | 0 | 0 | 20 | 20 | 5 | 786 | — | — |
| 2 | 0 | 0 | 43 | 43 | 10.3 | 155 | — | — |
| 3 | 3.75 | 6.25 | 43 | 40 | 12.1 | 226 | 17% | 46% |
| 4 | 7.5 | 12.5 | 47 | 40 | 12.1 | 224 | 17% | 44% |
| 5 | 15 | 25.0 | 43 | 26 | 11.1 | 673 | 8% | 334% |
| 7 | 30 | 50.0 | 66 | 37 | 14.6 | 457 | 42% | 195% |
| 6 | 60 | 100 | 100 | 0 | 22.1 | — | | |

The discharge voltages of cycle no. 5 as a function of the discharged capacity, for examples 2 to 7, are shown in FIG. 5. Example 6 does not contain MnO₂ and has a discharge profile only of nickel hydroxide, very different from the discharge profile of example 2, purely MnO₂.

The additions of Ni(OH)₂ of 3.75% and 7.5%, respectively, for examples 3 and 4 do not modify the discharge profile of example 2.

With an addition of 15% of Ni(OH)₂ for example 5, a slight shoulder at the beginning of the discharge is visible, but the discharge profile remains very close to example 2, purely MnO₂. This result suggests, for cycle no. 5 of examples 3, 4, and 5, that Ni(OH)₂ contributes very little to the discharged capacity. In fact, considering that the discharge of Ni(OH)₂ under these test conditions is 95% (demonstrated in example 6), the 43% discharge of example 5 should be distributed at 21% over Ni(OH)₂ and 22% over MnO₂. The shoulder of example 5 is in accordance with a contribution to the discharge of Ni(OH)₂ of less than 3%. This difference between a maximum calculated contribution (21%) and what could be deducted from the discharge curves (3%) can be explained by the fact that Ni(OH)₂ is not fully charged under the applied cycling conditions.

In fact, the voltage does not increase sufficiently in the charge curves to reach the voltages corresponding to the charge of Ni(OH)₂. With example 7, characterized by an identical amount between the two active electrochemical phases MnO₂ and Ni(OH)₂, the discharge profile is hybrid with a wide shoulder of up to 30%, characteristic of the discharge voltage of Ni(OH)₂ then a fairly slow drop in the voltage corresponding to the discharge of MnO₂. For this example 7, considering a 95% discharge for Ni(OH)₂, the 66% discharge of example 7 should be distributed at 44% over Ni(OH)₂ and 22% over MnO₂. The shoulder of the discharge of cycle no. 5 of example 7 corresponds to a contribution of the discharge of Ni(OH)₂ of less than 44%, implying that, in this example, Ni(OH)₂ participates not maximally, but more than in examples 3, 4, and 5, with its discharge remaining partial, as can be seen in FIG. 5.

Here again, the difference between a maximum calculated contribution (44%) and the deduction from the discharge curve is explained as mentioned above.

The discharge voltages of cycle no. 50, as a function of the discharged capacity, for examples 2 to 7, are shown in figure.

The discharge voltage profiles of examples 3, 4, 5 and 7 are strongly modified with the presence of a shoulder increasing with the Ni(OH)₂ content. This shoulder is correlated with the discharge of Ni(OH)₂. The shoulders of examples 5 and 7 are respectively around 25% and 45%, values close to the calculation of a maximum contribution of Ni(OH) 2, respectively 21% and 44%. The reason for a better agreement here between the maximum calculated contribution of Ni(OH)₂ and the values deducted from the curve could be explained by the fact that Ni(OH)₂ charges more than at the beginning of cycling, because MnO₂ gradually loses its cycling performance. After the shoulder, the continuation of the discharge is correlated with the contribution of the discharge of MnO₂, but the voltage is higher than for cycles no. 5, demonstrating a significant change in the discharge behavior of this MnO₂ phase.

This result reveals in situ modifications during the first 50 cycles concerning the MnO₂ and Ni(OH)₂ phases. Ultimately, the increase in the cyclability of the manganese dioxide suggests that the capacity loss associated with the formation of the parasitic Mn₃O₄ and ZnMn₂O₄ phases is limited. FIG. 7 shows the X-ray diffraction diagrams for:
1: a mixture with a composition of 50% MnO₂, 50% Ni(OH)₂, and 6% Bi₂O₃, identical to the mixture of these 3 phases used in example 7;
2: the active material of an electrode identical to example 7, after 5 cycles;
3: the active material of an electrode identical to example 7, after 20 cycles;
4: the active material of an electrode identical to example 2, after 5 cycles;
5: the active material of an electrode identical to example 2, after 26 cycles.

The X-ray diffraction diagram of preparation 1 is characterized by the diffraction peaks of the β-Ni(OH)₂ and Bi₂O₃ phases. The diffraction peaks of the MnO₂ phase are not identified, indicating that this MnO₂ phase is insufficiently crystallized to be visible in the presence of the other β-Ni(OH)₂ and Bi₂O₃ phases. For examples 2, without Ni(OH)₂ in the active material, preparations 4 and 5, the diagrams are similar, with very few diffraction peaks, attesting to the low crystallization in accordance with the initial MnO₂ phase. The parasitic ZnMn₂O₄ phase is not identified in these diagrams. For examples 7, the X-ray diffraction diagrams demonstrate, compared to preparation 1, a significant crystal transformation with the presence of peaks at low angles around 11-13 degrees, suggesting lamellar crystal phases with insertion. Diagram 3 differs from diagram 2 by the formation of a shoulder in the first peak, which indicates a structural change. This physical-chemical analysis associates the capacity stabilization with an in-situ crystal transformation between the initial active MnO₂/β-Ni(OH)₂ phases.

In contrast to patent JP H10 74511 A, significant additions of Ni(OH)₂, such as 50% relative to MnO₂, example 7, stabilizes the capacity of the hybrid electrode. The crystal result and the remarkable change in the discharge voltage, which increases between cycles 5 and 50, demonstrate an in situ and progressive transformation with the number of cycles of the compounds MnOOH/MnO₂ and Ni(OH)₂/NiOOH. This in-situ transformation demonstrates greater stabilization of the discharge capacity for this new MnO₂/Ni(OH)₂ hybrid electrode. The presence of stable Ni(OH)₂/NiOOH crystallites in the alkaline electrolyte, providing a crystal growth substrate for the MnOOH/MnO₂ compounds, a substrate susceptible to increasing the reversibility of the electrochemical couple MnOOH/MnO₂ by an increase in the coherence domains of these compounds, has not been completely demonstrated. But the stabilization of the capacity is correlated with a new phenomenon suggesting an in-situ modification between the Ni(OH)₂/NiOOH and MnOOH/MnO₂ compounds.

### SCIENTIFIC PUBLICATIONS MENTIONED IN THE INTRODUCTION

¹ K. Kordesch, J. Gsellmann, M. Peri, K. Tomantschger, and R. Chemelli, Electrochim. Acta, 26, 1495 (1981)
² F. R. McLarnon and E. J. Cairns, J. Electrochem. Soc., 138, 645 (1991)
³ T. C. Adler, F. R. Mclarnon, and E. J. Cairns, J. Electrochem. Soc., 140, 289 (1993)
⁴ A. Kozawa and J. F. Yeager, J. Electrochem. Soc., 112, 959 (1965)
⁵ R. Patrice, B. Gerand, J. B. Leriche, L. Seguin, E. Wang, R. Moses, K. Brandt, and J. M. Tarascon, J. Electrochem. Soc., 148, A448 (2001)
⁶ J. W. Gallaway, B. J. Hertzberg, Z. Zhong, M. Croft, D. E. Turney, G. G. Yadav, D. A. Steingart, C. K. Erdonmez, and S. Banerjee, J. Power Sources, 321, 135 (2016)
⁷ K. Kordesch and J. Gsellmann, U.S. Pat. No. 4,384,029 (1983)
⁸ K. Kordesch, J. Daniel-Ivad, E. Kahraman, R. Mussnig, and W. Toriser, in The ASME 26th Intersociety Energy Conversion Engineering Conference, Paper 910052, Boston, MA, Aug. 4-9 (1991)
⁹ L. Binder, K. Kordesch, and P. Urdl, J. Electrochem. Soc., 143, 13 (1996)
¹⁰ N. D. Ingale, J. W. Gallaway, M. Nyce, A. Couzis, and S. Banerjee, J. Power Sources, 276, 7 (2015)
¹¹ M. Minakshi, P. Singh, J. Solid State Electrochem. 16 (2012) 2227
¹² D. Im, A. Manthiram, B. Coffey, J. Electrochem. Soc. 150 (2003) A1651
¹³ A. M. Kannan, S. Bhavaraju, F. Prado, M. M. Raja, A. Manthiram, J. Electrochem. Soc. 149 (2002) A483
¹⁴ J. Daniel-Ivad, E. Daniel-Ivad, R. J. Book, Additives for Rechargeable Alkaline Manganese Dioxide Cells, U.S. Pat. No. 6,361,899 B1, 2002
¹⁵ J. Daniel-Ivad, Rechargeable Alkaline Manganese Cell Having Reduced Capacity Fade and Improved Cycle Life, WO2007059627A1, 2007
¹⁶ M. R. Bailey, S. W. Donne, J. Electrochem. Soc. 159 (2012) A999
¹⁷ A. Stani, W. Taucher-Mautner, K. Kordesch, J. Daniel-Ivad, J. Power Sources 153 (2006) 405
¹⁸ G. G. Yadav, J. W. Gallaway, D. E. Turney, M. Nyce, J. Huang, X. Wei, and S. Banerjee, Nat. Commun., 8, 14424 (2017)
¹⁹ G. G. Yadav, X. Wei, J. Huang, J. W. Gallaway, D. E. Turney, M. Nyce, J. Secor, and S. Banerjee, J. Mater. Chem. A, 5, 15845 (2017)
²⁰ J. Huang, G. G. Yadav, J. W. Gallaway, X. Wei, M. Nyce, and S. Banerjee, Electrochem. Commun., 81, 136 (2017)
²¹ M. Kelly, J. Duay, T. N. Lambert and R. Aidun. J. Electrochem. Soc. 164 (14) A3684 (2017)
²² T. N. Ramesh, P. Vishnu Kamath, Journal of Power Sources 175 (2008) 625-629

1. A zinc-manganese hybrid secondary electrochemical generator, comprising:
a) a positive hybrid electrode containing a mixture of manganese dioxide (MnO2) and nickel hydroxide (Ni(OH)2), the mass of Ni(OH)2 being greater than 5% of the sum of the masses of Ni(OH)2 and MnO2, and
b) an electrolyte that is an alkaline aqueous solution with a molarity of between 4 M and 15 M of hydroxyl anions.

2. A secondary electrochemical generator according to claim 1, wherein the mass of Ni(OH)2 is greater than 20% of the sum of the masses of Ni(OH)2 and MnO2.

3. A secondary electrochemical generator according to claim 1, wherein the zinc negative electrode contains conductive ceramics.

4. A secondary electrochemical generator according to claim 3, wherein the zinc negative electrode contains titanium nitride.

5. A secondary electrochemical generator according to claim 1, wherein the molarity of the alkaline solution is between 7 and 13 M.

6. A secondary electrochemical generator according to claim 1, wherein the alkalinity of the electrolyte solution is provided by lithium and/or sodium and/or potassium hydroxides.

7. A secondary electrochemical generator according to claim 1, wherein the electrolyte further contains zincate ions.

8. A secondary electrochemical generator according to claim 1, wherein the electrolyte further contains borates, silicates, and/or aluminates.
